(19) United States
(12) Patent Application Publication
(10) Pub. No.: US 2024/0320038 A1
(43) Pub. Date: Sep. 26, 2024

(54) USER ACCOUNT OBJECT MANAGEMENT

(71) Applicant: Immersive Labs Holdings Limited, Bristol (GB)

(72) Inventor: Matthew PARVEN, Bristol (GB)

(21) Appl. No.: 18/680,361

(22) Filed: May 31, 2024

Related U.S. Application Data
(63) Continuation of application No. PCT/EP2022/081760, filed on Nov. 14, 2022.

(30) Foreign Application Priority Data
Dec. 2, 2021 (GB) 2117391.9

(51) Int. Cl. G06F 9/48

(52) U.S. Cl. CPC G06F 9/4881

(57) ABSTRACT

A method, system and computer-readable medium for managing user account objects within a digital environment via a framework. The framework comprising: an API enabling a user to send and receive commands to the digital environment; a database having user account objects associated with a pool of user account objects; and an isolated network segment with resources for performing a task. The method comprises receiving a request, via the API, from the user to perform the task, and activating a user account object from the database. The user account object is configured for performing the requested task; and a command from the user, using the configured user account object, is received at the isolated network segment, to enable the task to be completed. The user account object is deallocated when a completion indication is detected from the isolated network segment. Deallocation comprises dissociating the user account object with the user.

### CROSS-REFERENCE TO RELATED APPLICATIONS

This application is a continuation under 35 U.S.C. § 120 of International Application No. PCT/EP2022/081760, filed Nov. 14, 2022, which claims priority to GB Application No. GB2117391.9, filed Dec. 2, 2021, under 35 U.S.C. § 119(a). Each of the above-referenced patent applications is incorporated by reference in its entirety.

### BACKGROUND

### Technical Field

Embodiments disclosed within relate to a method, system, and computer-readable medium for managing user account objects in a digital environment, in particular, for managing user account objects in a cloud computing environment.

### Background

Cloud computing environments enable multiple computing resources to be accessed remotely and even enable devices to independently access shared resources, such as physical computing devices or virtual machines, servers, device memory and storage devices. Digital environments that make use of such cloud computing environments allow multiple users from different businesses, sometimes in different locations, to access and make use of a single cloud computing environment to participate in tasks.

Using a cloud computing environment for multiple users enables the sharing of resources, thereby optimising the number of resources required. However, enabling multiple users to access the shared resources in a cloud computing environment, can introduce several problems and limitations. For example, enabling multiple users to access the resources can increase the chance of data breaches, and increase resource usage and therefore costs for implementing the digital environment using a cloud computing environment.

### SUMMARY

According to a first aspect of the present invention, there is provided a method for managing user account objects within a digital environment via a framework, the framework comprising: an application programming interface, API, the API enabling a user to send and receive commands to the digital environment; a database comprising a plurality of user account objects, each user account object being associated with a pool of user account objects; and at least one isolated network segment configured to perform at least one task, the isolated network segment comprising a plurality of dynamically instantiable resources; the method comprising the steps of: receiving a request, via the API, from the user to perform the task; activating a user account object from the database, by associating the user account object with the user and the isolated network segment; configuring the user account object for performing the requested task; receiving at the isolated network segment, at least one command from the user, to enable the task to be completed within the isolated network segment, wherein the at least one command is sent by the user using the configured user account object; and deallocating the user account object upon detection of a completion indication from the isolated network segment indicating the completion of the task, wherein deallocation comprises dissociating the user account object with the user and associating the user account object with the pool of user account objects. This enables efficient management of user account objects in the pool of accounts, removing the time and resource-intensive deletion process and reducing the number of idle user account objects. Furthermore, having a pool of user account objects stored in a database enables the most appropriate user account object to be activated and allocated to a user and isolated network segment based on the requested task, and configured specifically for performing the task. Sending commands using the configured user account object enables the user to communicate with the task they have requested since the user and the isolated network segment used for running the task are allocated to the user account object, whilst also limiting the actions of the user for example, by preventing the user from increasing their security privileges and ensure that users do not undertake operations outside of the scope of the task. By communicating using the user account object, multiple users can access resources within the isolated network segment, thereby further reducing resource requirements since a single isolated network segment may provide resources for a plurality of users. By deallocating the user account object and returning it to the pool of user account objects upon receipt of a completion indication, the user account object may be reused by subsequent users who request to perform a task.

Optionally, the step of configuring the user account object comprises provisioning one or more attributes of the user account object for performing the requested task. This enables the attributes of 0the user account objects to be instantiated based on the task requested by the user and therefore customized based on the specific requirements of the task.

A plurality of user account objects may be activated and allocated to the user and, the step of configuring the plurality of user account objects may comprise provisioning each of the plurality of user account objects with differing attributes for performing the requested task. Using multiple user account object to be allocated to the user enables the user to access the isolated network segment using any one of the accounts, and therefore enables the user to participate in tasks that require interaction between multiple actors, without having to set up individual accounts for each actor.

Preferably, the method further comprises selecting one or more pre-provisioned user account objects from the database, the one or more pre-provisioned user account objects comprising at least one required attribute for performing the requested task. By activating and allocating user account objects which comprise pre-provisioned attributes, enables users to participate in tasks where specific information regarding the task is a prerequisite, without the need to configure the user account objects beforehand. This is particularly beneficial when the configuration of a user account object is time-consuming since a sub-pool of pre-configured user account objects can be maintained and provided to the user when they request to perform a task requiring such a user account object.

The attributes may comprise at least a security level configured to limit access of the user to at least one of the resources of the isolated network segment based on the requested task. Setting a security level attribute when the user account object is configured enables the user account object, and therefore the user sending commands through the user account object, to be limited, restricting the user's access to certain resources, and preventing unauthorised access to resources within the digital environment.

Optionally, the method further comprises the step of instantiating the isolated network segment by configuring the plurality of dynamically instantiable resources for performing the requested task. Instantiating the isolated network segments by configuring the resources within it for performing the task enables the user account object information to be used during the configuration of the resources, such that only the user account object allocated to the user and the isolated network segment can be used to interact with the resources required for performing the task. This enables resources for a given task to exist in the same isolated network segment alongside resources for another task, whilst maintaining a highly secure environment.

The plurality of dynamically instantiable resources of the isolated network segment may be pre-configured for performing one or more requested tasks. By using isolated network segments with pre-configured resources, a reduction in the processing time and resource usage can be achieved since the resources of the isolated network segment don't need to be configured. This is particularly beneficial when the resources take a long time to configure, such as when setting up a VPN. This, therefore, reduces the load time for the end-user and allows them to interact with/perform the task with little/minimized load time.

Preferably, the user, and the allocated user account object, are associated with a given organization. Some organizations wishing to use the digital environment for performing tasks may require a highly secure environment or may require a large number of user account objects regularly. The organization may also wish to customize the user account objects in some way. Therefore, by associating the user account objects with the organizations, users from the organization can ensure they have access to the necessary user account objects when required for performing the task, without the need to provision more user account objects with the cloud service provider and customize them for their particular requirements.

The at least one command received by the isolated network segment may be received via an intermediary component. Using an intermediary component enables resources from multiple isolated network segments to communicate, and also enables the monitoring of commands sent between the isolated network segment and the users and acted upon, such as an indication of the completion of a task.

Optionally, the step of deallocating the user account object further comprises resetting the user account object. By resetting the user account object during deallocation, the user account object can be reused for different tasks and by different users. Furthermore, it allows certain aspects of the user account object to be maintained where appropriate, such as when a preconfigured user account object was selected from the pool of accounts. This removes the need to reconfigure the user account object thereby resulting in more efficient use of existing resources.

The plurality of resources may be virtual machines. The digital environment may be representative of a computer network. The virtual machines represent computer systems, and the digital environment represents a computer network for use in a task, and as such reduce the required amount of physical hardware required to implement the task.

According to other aspects of the present disclosure, there is provided a system configured to perform the method steps set out above, and a non-transitory computer-readable storage medium comprising instructions which, when executed, cause a computing device to perform the method steps set out above.

### BRIEF DESCRIPTION OF THE DRAWINGS

Further features and advantages of the invention will become apparent from the following description of preferred embodiments of the invention, given by way of example only, which is made with reference to the accompanying drawings.

FIG. 1 shows a framework for managing user account objects in digital environments according to an example;

FIG. 2 is a flowchart showing a method for managing user account objects in a digital environment according to an example;

FIG. 3 shows user account objects according to an example;

FIG. 4 shows schematically the flow of commands for enabling a selected task to be completed; and

FIG. 5 shows a system for managing user account objects in a digital environment according to an example.

### DETAILED DESCRIPTION

Embodiments described herein relate to methods and systems for managing user account objects in a digital environment, in particular, managing user account objects in cloud computing environments.

Cloud computing is a model for service delivery enabling on-demand network access to shared resources including processing power, memory, storage, applications, virtual machines, and services, that can be instantiated and released with minimal effort and/or interaction with the provider of the service. Cloud computing environments enable quick and cost-effective expansion and contraction of such resources by enabling the provisioning of computing capabilities, such as server time and network storage as needed. Cloud computing enables the service provider's resources to be pooled and to serve multiple consumers by dynamically assigning and reassigning physical and virtual resources on demand. Examples of such services include Amazon Web Service™ (AWS), Microsoft Azure, and Google Cloud Platform.

Services delivered using a cloud computing environment are often referred to a Software as a Service (SaaS). The applications are accessed from various client devices through a basic interface, such as a web browser. A user of the application generally has no control or knowledge over where the provided resources are located or in some examples where multiple service providers are used, which service provider is providing the resources; access to the resources of the cloud computing environments is provided via a user account object which facilitates the user's interaction with the resources allocated to a given task within the cloud computing environment. Whilst the examples below refer to the management of user accounts within a cloud computing environment, it will be appreciated that other environments may be used, such as a collection of servers within a local area network (LAN).

Example applications include digital training environments, which enable users to develop and enhance their skills in a particular area, as well as keep updated with any relevant developments, issues, and solutions. Some digital environments combine multiple topics and enable users to undertake tasks covering those areas. Furthermore, digital environments allow management teams to track the progress of particular users to ensure a standard level of competence is achieved across their workforce, and where necessary provide updates and additional tasks in particular areas.

A single digital environment may be provided as a platform for multiple companies to provide activities in a particular area for individuals or groups of employees, and as such, being able to separate the tasks on a per company, per team, or even per employee basis is desirable. Furthermore, it is necessary to ensure that there are sufficient resources available to provide the required task and sufficient user account objects for the employees. Different tasks may have different requirements, such as a task that requires the implementation of multiple virtual machines versus a task that requires the implementation of a single virtual machine. Some tasks may also require multiple user account objects. Therefore, the management of such resources and user account objects is important to ensure the efficient, secure, and cost-effective performance of tasks. By implementing a digital environment in a cloud computing infrastructure, the digital environment can dynamically assign and reassign resources such as virtual machines, other platform-independent applications and the resources used to implement them, as well as assign and reassign pre-existing user account objects. This enables the efficient management of the resources and user account objects as well as decreasing the costs of implementing the applications in the cloud computing environment since multiple users/groups of users can share the digital environment.

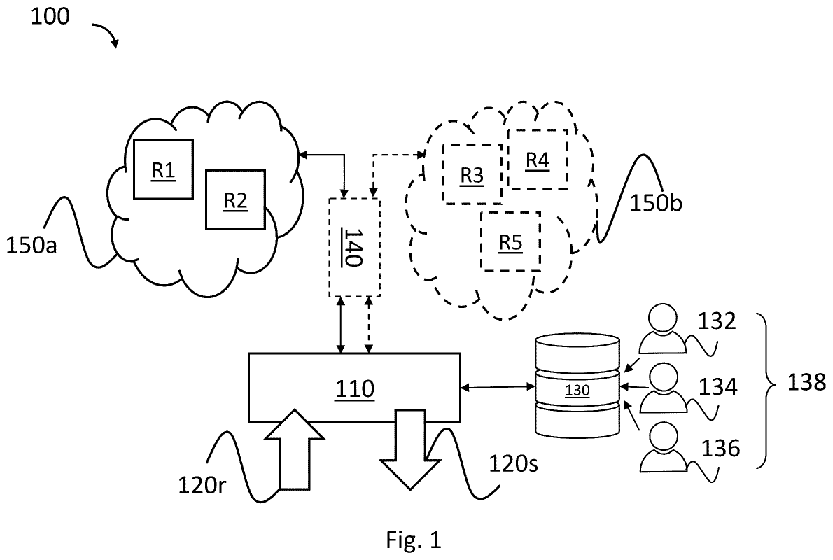

FIG. 1 shows schematically a framework 100 for managing user account objects in a digital environment according to an example. The framework comprises an application programming interface (API) 110, a database 130, and at least one isolated network segment 150a, 150b.

The API 110 is arranged to receive one or more commands 120r from a user device (not shown) to perform a task, which requires the allocation of a user account object 132-136, such as a user account object 132-136 described in further detail below. The user device may be a remote device, such as a desktop computer, mobile telephone, or other device arranged to communicate with the framework 100 via a network connection, such as via the internet, or a direct connection to a server of other computing devices capable of running the framework 100. The user device may access the resources associated with the framework via a software program such as a web browser or other application installed on the user device which facilitates the connection to the framework 100 via the API 110. The API 110 is also arranged to send one or more commands 120s to the user device. For example, if a user initiates a task within a digital environment, the user device will send commands to the framework 100 which will initiate the digital environment, any resources required by the digital environment, and associate and configure a user account object 132-136 from the database 130. The framework 100 can also facilitate commands for interacting with and participating in the exercise using the resources R1-R5.

The API 110 supports multiple commands 120r for interacting with one or more resources associated with the framework 100, including initiation commands for allocating and configuring the user account objects 132-136. In some examples, the API 110 also supports interaction commands for interacting with the resources R1-R5 of the isolated network segments 150a, 150b. Such commands are received from a user device as indicated by arrow 120r, into the API, which in turn enables the framework to process the commands.

A plurality of user account objects 132-136 may be set up by a provider of the digital environment and stored in a database 130. Each user account object 132-136 may be initialized such that the framework 100 can assign/allocate it to a user wishing to undertake a task in the digital environment using one or more isolated network segments 150a, 150b. The database 130 may comprise any number of user account objects 132-136 which are instantiated with the cloud service provider, such as AWS and/or Azure, and may be used by users to undertake tasks. In some examples, the user account objects 132-136 are unconfigured such that they are capable of being configured or customized as required by the task, and the user who wishes to undertake the task. In other examples, a subset of the user account objects 132-136 in the database is preconfigured and/or partially preconfigured such that certain attributes are capable of being implemented without further configuration. This is particularly beneficial when attributes may take a large amount of time to configure, such as when setting up virtual private networks or attributes which require communication with remote servers/services to be populated. Further details regarding the attributes are provided below with reference to FIG. 3.

User account objects 132-136 may be set up with the cloud service provider as required; for example, an initial pool of user account objects can be instantiated and stored in the database 130, and when the pool drops below a threshold number, additional accounts may be instantiated. This ensures that accounts are only set up if needed, thereby reducing resource usage and ultimately costs. This is particularly important when cloud service providers enable the easy creation of accounts but limit the automatic deletion/closing of accounts to ensure any outstanding costs for cloud service provider resources are paid up before closure. This limitation often results in large numbers of closures having to be undertaken periodically, which is time-consuming and resource intensive. By managing the number of user account objects 132-136 in such a way the setup of user account objects 132-136 can be limited to only those required therefore reducing or removing the requirement for the time-consuming closure process. The use of user account objects also allows third parties to complete tasks using user account objects managed by the service provider, without the need for each third party to set up their own accounts.

In some examples, the pool of user account objects stored in the database 130 comprises a plurality of sub-pools of user account objects. Each sub-pool of user account objects may comprise user account objects 132-136 which are customized for a particular organization and/or group of users and preconfigured in some way for tasks that those organizations or users are likely to request to complete. This further minimizes the creation of excess user account objects, increasing the efficiency and reducing costs since user account objects of not need to be set up/customized for the organization each time they are allocated to a user of that organization. In addition to the increase in efficiency, increased security is also achieved, as the user account objects 132-136 can be limited to prevent access to resources of the digital environment. For example, the permissions on created accounts may be limited to only allow access/interaction with pre-existing tasks, whereas an administrator may have overarching access and the ability to create tasks via a different account. Other security levels may also be implemented, for example, administrators at an organization implementing the framework 100 may have the ability to customize aspects of the tasks, but not create them. This prevents the user account objects 132-136 from being able to amend or achieve the permissions level to amend, the tasks.

By using a pool of user account objects, user account objects 132-136 can be stored in the database and reused by different users when they perform the task. Furthermore, the use of sub-pools, as will be described below, enables user account objects to be grouped, and in some examples preconfigured for particular tasks, such that when the particular task is requested a preconfigured user account object 132-136 is selected from the sub-pool. The reuse of user account objects 132-136 reduces the resources required and increases the efficiency since additional steps to set up an account with the cloud service provider are not required. The user account object 132-136 can simply be configured or partially configured to perform a given task and, on request, can be allocated to a user who wishes to undertake that task.

As mentioned above, the framework 100 comprises at least one isolated network segment 150a, 150b. An isolated network segment is a collection of resources R1-R5, such as a virtual private cloud in an environment provided by AWS or as a VNet in an environment provided by Azure, which are interconnected in a virtual network specified on instantiation for the requested task. The resources R1-R5 may have a plurality of characteristics which may include a type of virtual machine or container, such as Kubernetes, or a Microsoft Windows® virtual machine, data to be stored in storage associated with the virtual machine, configuration information, such as an IP address associated with the resource, information about other resources which form part of a virtual network of the digital environment, and capabilities of the particular resource. Users access and interact with the resource R1-R5 of the isolated network segment by sending and receiving commands using a configured user account object 132-136 selected from the database 130. The selected user account object 132-136 may be a blank user account object, a preconfigured user account object, or a partially preconfigured user account object. The type of selected account may be dependent on the task to be performed by the user.

The isolated network segment 150a, 150b, enables the resources R1 required for one task and the resources R2 required for another task to be separated whilst existing on the same network, or even within the same isolated network segment 150a, and enables different users to access resources R1, R2 via their respective user account objects. This may be implemented through the allocation of a private IP subnet, or a set of encrypted communication channels which serve to isolate the resources R1-R5 on a per-user basis and enable communication with said resources R1-R5 via the user account object 132-136.

The following examples describe embodiments with reference to an isolated network segment, however, it will be appreciated that any computing environment, cloud-based or otherwise may be used. Each isolated network segment 150a, 150b may represent a different digital environment, such as a digital environment for running a task for a single user or multiple users concurrently. Alternatively, each isolated network segment 150a, 150b may comprise multiple digital environments having one or more resources R1-R5 for use by different users from different organizations.

For example, where a provider creates a particular task, multiple organizations may wish their employees to participate in that particular task, and as such different users from different locations and different companies can access the same isolated network segment 150a to participate in said task. In some examples, a task requires a user to have access via multiple user account objects 132-136 and as such, each user may be allocated multiple user account objects 132-136. Each employee assigned to participate in that task may access the task via a user account object 132-136 which has been allocated to them and the isolated network segment 150a, enabling them to, at least, send and receive commands using the user account object 132-136. In some examples, as described above, some organizations require employees to interact with/participate in the task via their own sub-pool of user account objects and as such, the account allocated to the employee will be selected from the sub-pool of user account objects rather than the larger pool of user account objects. This is also the case for tasks created by or for a particular organization, such as where tasks have been customized for a particular organization. In other examples, the task created by the provider can require the user account objects 132-136 to have certain properties and/or attributes. The initialization of such properties and/or attributes can consume a large amount of time and/or resources. Therefore, in some examples, a sub-pool of user account objects is preconfigured or partially preconfigured with user account objects 132-136 already having these properties/attributes initialized. As a result, when a user is allocated a task that requires a user account object 132-136 with such attributes/properties, the user account object 132-136 allocated to them, and the isolated network segment to perform the task may be one of the preconfigured user account objects 132-136 from the sub-pool of user account objects.

According to some embodiments, users, via their configured user account objects 132-136, may send commands to the Resource R1-R5 for participating in the task. For example, one or more of the resources R1-R5 may be used as a virtual representation of a computer network for the purposes of undertaking a test or other task, such as a sandboxing scenario for checking the robustness of a computer system. Each of the resources R1-R5 may be individually provisioned from external hardware (not shown) and accessed via the isolated network segment 150a, 150b. When a task is instantiated, the associated resources R1-R5 may be provisioned from the external hardware and be provided within a particular isolated network segment 150a, 150b. The isolated network segment 150a, 150b may be used to define the interactions between those resources R1-R5, and as described above may provide resources for any number of tasks at the same time, each task being accessible by different users using their respective user account objects 132-136.

As described above, some provisioning steps may take considerable time and/or resource to instantiate. To alleviate these issues the resources R1-R5 of the isolated network segment 150a, 150b may be pre-instantiated and remain in an instantiated state. For example, the setup of a virtual private network is particularly resource-intensive, and therefore some isolated network segments 150a, 150b with pre-instantiated virtual private networks may be maintained in the digital environment. In such examples, users are allocated user account objects 132-136 which are preconfigured with at least the virtual private network information, thereby increasing the efficiency of allocation, and configuring such accounts, enabling quick access to the task.

In some examples, an optional intermediary component 140 is arranged to manage the resources R1-R5 associated with framework 100 and facilitate communication with and/or between the resources R1-R5 and the user via the API 110. The intermediary component 140 as described in the examples below is located outside of the isolated network segment 150a, 150b, however, it will be appreciated that the intermediary component 140 may form part of the isolated network segment 150a, 150b, such that the intermediary component is arranged to proxy communications between the API 110 and the resources R1-R5 within the isolated network segment 150a, 150b. Furthermore, the intermediary component 140 may comprise components, some of which form part of the isolated network segment 150a, 150b and some of which are remote to the isolated network segment 150a, 150b. The intermediary component 140 receives commands via the API 110, communicates with the necessary resources R1-R5 and in some examples, with hardware (not shown) external to the framework 100. Accordingly, the intermediary component 140 is arranged to proxy communications between the API 110 and the one or more resources R1-R5 within a given isolated network segment 150a, 150b. Where the user commands are pass via the API 110, this can, for example, enable multiple users, via their own allocated user account objects 132-136, to interact with the same or separate resources within the same digital environment, or enable a single user to interact with resources in different digital environments.

Users may not only use the framework 100 for interacting with resources R1-R5 in the isolated network segments 150a, 150b as indicated by the arrows but may also use the framework 100 to initialise resources R1-R5 for example, where a task requires a user to initialise a particular resource. When a user is undertaking a task, commands can be sent from a user device (not shown) using the user account object 132-136 to each of the resources R1-R5 for further processing. In examples involving the use of an intermediary component 140, where tasks require the interaction of multiple resources R1-R5 across multiple digital environments, the isolated network segment 150a, 150b and intermediary component 140 may be configured to allow interaction between the resources R1-R5 in a single isolated network segment 150a, 150b, as and when required. In some examples, the intermediary component 140 enables the resources R1-R5 of separate isolated network segments 150a, 150b to communicate with each other.

In some examples, the resources R1-R5 pass parameters back to the user device (not shown) via a return command 120s. Such return commands 120s indicate the completion of a task, and or other actions required to be undertaken by the user to progress the task. The return commands are provided from the resources R1-R5 to the user device via the user account object 132-136. In examples with an intermediary component 140, the return command 120s is passed via the intermediary component 140 to the API 110 and then to the user via the user account object 132-136. Providing the intermediary component 140, separates the API 110 from the resources R1-R5, thereby increasing security by preventing direct access to the individual resources R1-R5, whilst enabling user interaction with multiple different isolated network segments 150a, 150b via their user account objects 132-136 and the API 110. Security is further increased when the intermediary component 140 is provided as part of an isolated network segment 150a, 150b, since all interactions within are undertaken within the isolated network segment 150a, 150b, and external communication is only undertaken via the intermediary component 140. This is particularly important for certain tasks, especially when the tasks are related to security, and intrusion detection and prevention, where the aim of the task is to obtain unauthorised access to one or more of the resources R1-R5. The intermediary component 140 therefore, polices any commands sent via the API 110 before passing the commands onto the individual resources R1-R5.

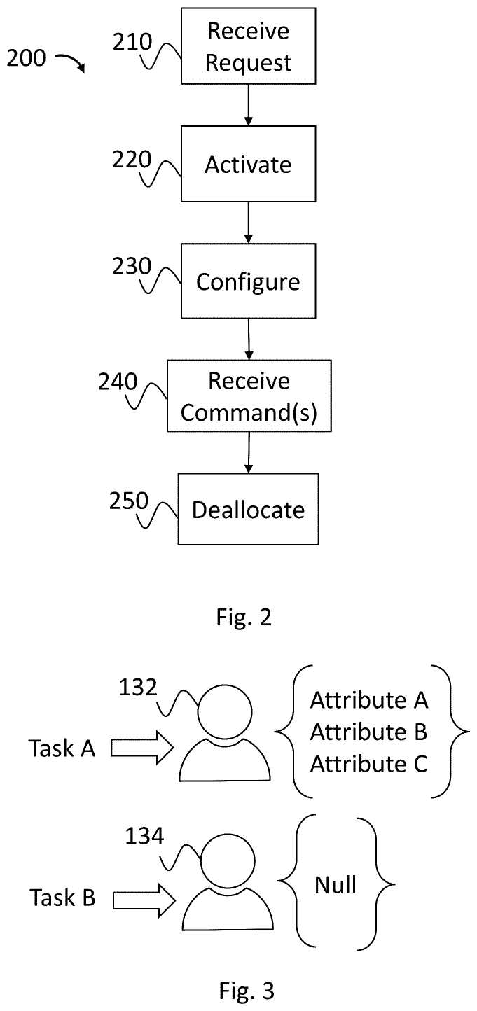

FIG. 2 is a flowchart 200 showing a method of managing the user account objects within a digital environment according to an example. The process of managing the user account objects is undertaken using the framework 100 described above with reference to FIG. 1.

At step 210, a request is received from a user device, such as a desktop computer, mobile telephone, or tablet computer. The request, such as command 120r shown in FIG. 1, is received via the API 110. By receiving the requests through the API 110, a generic interface with external devices can be used. This enables multiple different types of user devices with different operating systems and requirements, to interact with the framework 100. By using a generic interface, interaction with the framework 100 is simplified and access from different locations, and using devices with different capabilities, hardware and/or software is enabled.

The API 110 can handle several different incoming commands 120r, including requests to initialize a digital environment comprising one or more resources R1-R5 such as an isolated network segment 150a, 150b, and also activate one or more user account objects 132-136 for use by the user during when the participate in/interact with a task in the digital environment. As described above, the user device may access the digital environment via a software program such as a web browser or other application installed on the user device which facilitates connection to the framework 100 via the API 110. A user wishing to run a task in a digital environment, will request the task via the API 110, which results in the allocation of a user account object 132-136 that the user can use to send commands to perform the requested task as will be explained below.

Once the request 120r is received from the user, via the API 110, to perform a task, at step 220, one or more user account objects 132-136, stored in the database 130 and which make up the pool of user account objects, is activated. As described above, the pool of user account objects may comprise a plurality of sub-pools. The sub-pools may be associated with a particular organization that subscribes to the digital environment, that is a product that enables their employees to interact with/participate in tasks, and in other examples, the sub-pools comprise user account objects with particular attributes pre-configured. Activating the one or more user account objects 132-136, such as user account object 132, involves associating the user account object 132 with the user who sent the request 120r, and with the isolated network segment configured to perform the task that the user has requested. This enables the user to send commands for completing the task using the associated user account object 132 as will be described later. By associating the user account object 132 with a given user, the user account object 132 is removed from the pool. Removing the user account object 132 from the pool may involve indicating in the database 130 that the user account object 132 has been allocated to a given user. This will prevent the user account object 132 from being allocated to another user. It will be appreciated that other methods of indicating the association and preventing the allocated user account object 132 from being allocated to another user may be used.

In some examples, the user account object 132 that is activated is pre-configured/pre-provisioned with specific attributes according to the task that was requested. For example, where the task involves interaction with a virtual private network, one of the attributes which are preconfigured may be the login/connection information for the virtual private network. This reduces the time required since these attributes do not need to be set up each time the account is allocated to a user requesting such a task. The preconfigured/pre-provisioned user account object 132 may be stored in a separate sub-pool of the database 130.

Following the activation and association of the user account object 132 to the user and the isolated network segment 150a, 150b for performing the task, at step 230, the user account object 132 is configured for performing the requested task. Configuring may comprise provisioning one or more attributes, such as setting up log-in information, setting a security level, and in some examples associating the user account object with a particular resource R1-R5 of the isolated network segment 150a, 150b. In some examples, multiple user account objects 132-136, such as user account objects 132 and 133, are required to perform a given task, and as such each of the user account objects 132 133 is activated and associated with the user and the isolated network segment. During configuration at step 230, each of the activated user account objects 132, 133 may be configured differently, for example by applying different security levels, as required by the task for which they were requested. In some examples, the user account object 132 activated and allocated to the user may have been preconfigured or partially preconfigured. In such an example further configuration options may be undertaken as required by the task such as setting a username or password for interaction with a virtual private network. Other configuration options may include customizing the user account object 132 for an organization associated with the user who requested the task.

In some examples, the resources R1-R5 of the isolated network segment 150a, 150b are required to be instantiated and configured to perform the task, whereas in other examples the resources R1-R5 have already been instantiated. The optional step of pre-instantiating the resources R1-R5 can comprise configuring the resources with properties such as an IP address, firewall configuration, and/or actions to be undertaken in relation to one or more tasks. For example, by setting the IP address of each resource R1, R2, a communication channel between a first resource R1 and a second resource R2 can be defined with reference to the IP address provided to each resource R1, R2. In this example, the communication channel presents a connection state for both resources R1, R2.

Following the configuration of the user account object 132, and if required the instantiation of the isolated network segment 150a, 150b, at step 240 commands may be sent by the user using the configured user account object 132. The command is received by the isolated network segment 150a, 150b and the associated configured resources. In some examples, as described above, the request can be received via the API 110 and via the intermediary component 140. The commands sent by the user enable interaction with and participation in the requested task, with the aim of completing the task. As described above, using user account objects 132-136 enables multiple users to interact with the isolated network segment 150a, 150b and the resources R1-R5 at the same time. Furthermore, by only permitting commands to be sent using the user account object 132, increased security is provided since users are limited in their security privileges, such as by the attributes of the account, or limited in the increases they are able to apply to their security privileges by the nature of the digital environment. Such limitations may be as a result of a security policy implemented by the organization associated with the user account object, and/or a security policy implemented by the service provider.

After completion of the task, a completion indication is sent by the task, and at step 250 the user account object 132 is deallocated. Deallocating the user account object 132 involves adding the user account object 132 back to the pool of user account objects. Following from the example set out above, this may include indicating, in the database 130, that the user account object 132 is no longer allocated to a particular user and isolated network segment. In some examples deallocating the user account object 132 also involves resetting the user account object 132 by removing any of the configured attributes set up in step 230. Where the user account object 132 was preconfigured or partially preconfigured, the resetting of the user account object 132 may involve resetting the user account object 132 back to the preconfigured/partially preconfigured state. By returning the user account object 132 to the pool of user account objects, this enables subsequent users to be allocated the user account object 132 when they request a task, meaning additional user account objects do not need to be created, or only created if the pool of user account objects falls below a threshold. Allowing the reuse of the user account object 132 increases the efficiency as the steps to initialise a new user account object with the cloud service provider do not need to be performed as the account already exists. Furthermore, by limiting the number of user account objects created in this way, there is no need to undertake the deletion process mentioned previously since the user account object 132 can be reused by multiple users. This prevents a build-up of a large amount of unused user account objects which have only been used a single time.

FIG. 3 shows exemplary user account objects 132, 134 that have been assigned to a user and allocated to an isolated network segment for performing a task. User account object 132 has been allocated to a user that has requested, via a command passed through the API 110, to perform Task X. In such an example, user account object 132 has been preconfigured with several attributes, Attributes A, B, and C. In this example, Task X is a task that requires certain attributes of the user account objects interacting with it to be preconfigured, such as a VPN. Where the task requires the interaction with a VPN, the user account object 132 may be configured with usernames, passwords, and connection information, and this information is unlikely to change for each user. Therefore, by having a sub-pool of user account objects stored in the database 130 where these attributes are preconfigured, the time taken to implement the task and enable the user to perform or interact with the task is reduced. This is particularly useful, when obtaining the attribute information may take a large amount of time or rely on other aspects of the digital environment to be implemented beforehand. It will be appreciated that whilst the example user account object 132 shown in FIG. 3 shows only three attributes, there may be any number of attributes that are preconfigured. It will also be appreciated partially preconfigured user account objects may form part of the pool of user account objects or a sub-pool of user account objects. Such a partially preconfigured user account object comprises further attributes which are not preconfigured, and which may be configured as part of the configuration step 230 of FIG. 2. One such example includes the ability for a user to set their own password for accessing a VPN, whilst maintaining the connection information and username information that has already been preconfigured.

FIG. 3 also shows a user account object 134 allocated to a user who has submitted a request to perform Task Y. In this example, user account object 134 is a blank or white-label account where no attributes have been configured. Such an account may make up the pool of user account objects stored in the database 130. However user account object 134 may be part of a sub-pool of user account objects stored in the database 130 if the user and/or task requested is part of an organization that requires their own set/subset of user account objects for use by their employees or for use when undertaking tasks associated with the organization.

In some examples, the configuration and/or instantiation of attributes of the user account objects 132, 134 involves the population of fields as described above, and in other examples involves the implementation and provisioning of associated infrastructure, enabling the user account object to be customized to represent the user and requirements of the task specifically.

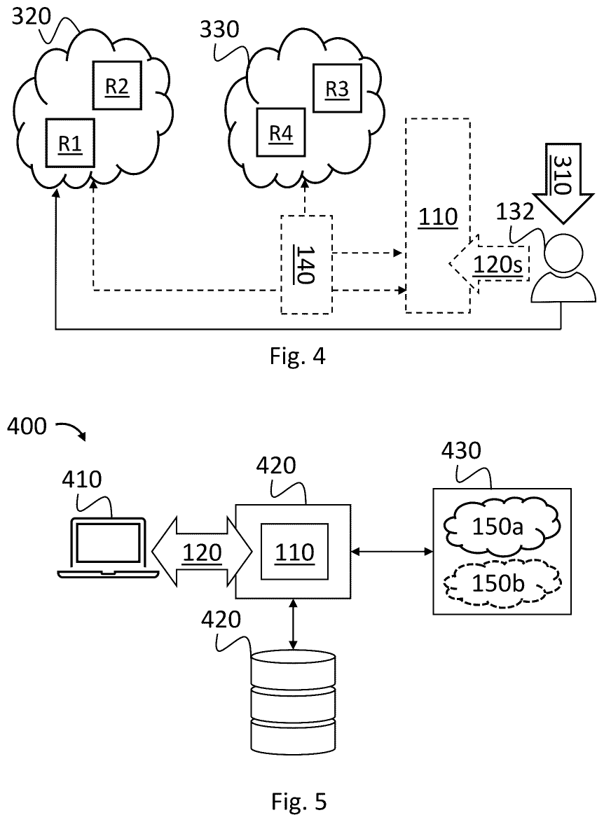

FIG. 4 shows schematically the flow of commands for enabling a selected task to be completed according to an example. A user has been allocated a user account object 132 when they sent the initial request to perform a task. The user account object 132 has been selected from a pool or sub-pool of user account objects stored in a database 132 of the framework 100 described above in relation to FIG. 1. The user account object 132 has also been allocated to the user for performing the task and associated with an isolated network segment 320 which comprises resources configured to perform the requested task. In some examples, the requested task requires the use of the resources of multiple isolated network segments, and therefore the user account object 132 may also be allocated to another isolated network segment, such as isolated network segment 330. As part of the initialisation, the user account object 132 is configured for performing the requested task. In some examples, as set out above, the user account object 132 is preconfigured for performing the requested task and is selected from a sub-pool of accounts in the database. Even when selecting a preconfigured account, specific attributes of the account may still be configured during the configuration step 230 described above regarding FIG. 2.

Following the initialisation, the user sends a request 310 to perform a task in a digital environment. Request 310 may be a command sent from the user via a computing device, such as a mobile telephone, tablet computer, desktop computer, or wearable device. Request 310 is then passed to the resources R1, R2 of the isolated network segment 320 allocated to the user account object 132, that is the isolated network segment 320 configured to perform the requested task. In some example, the command 310 may be passed via API 110 and/or intermediary component using the user account object 132. As explained above, the API 110 may support multiple commands for interacting with one or more resources associated with the framework 100, including requests for interacting with the resources R1, R2 of the isolated network segment 320 for performing the task and associated with the user account object 132. In such examples, requests 310 are received from a user device, through the user account object 132 as indicated by arrow 120s, into the API 110, which in turn enables the framework to process the request, and the task to be performed using the resources of the isolated network segment 320. As described above, some tasks may require the use of the resources of multiple isolated network segments 320, 330, in such examples an intermediary component 140 manages the interaction between the different isolated network segments 320, 330 of the digital environment.

FIG. 5 shows a system 400 comprising hardware components configured for operating the framework 100 described above in relation to FIG. 1, for managing user account objects. The system 400 comprises a user device 410 for interacting with a digital environment. The user device 410 may be any suitable device for receiving user inputs. For example, the user device 410 can be a mobile telephone, hand-held or laptop device, a desktop computer, a multiprocessor system, a microprocessor-based system, or a programmable consumer electronic device comprising an appropriate input method, such as a touch screen, a pointing device, keyboard, and/or trackpad. It will be appreciated that other types of user device 410 and input methods may be used. The user device 410 is configured with an operating system suitable for executing an application for interacting with the resources within the digital environment. The application may be a bespoke application designed specifically to run on the operating system of the user device 410. Alternatively, the application may be a web browser capable of handling a rich-web application which in turn is used to interact with the digital environment. Since the resources are remote from the user device 410, the user device 410 will be arranged to communicate with any number of remote resources via a network such as a local area network (LAN), a general wide area network (WAN), and/or a public network (e.g. the Internet) via a network adaptor. The network adapter may be configured to communicate using either a wired or wireless communication method, such as cellular connectivity (LTE, 3G, 4G, or 5G), ethernet, or over a Wi-Fi network.

The system 400 also comprises an intermediary server 420, which may be configured on the same network as the user device 410 or alternatively may be accessed via an external network such as the internet. The intermediary server 420 comprises an API 110 for interacting with the user device, storage 430, and the remote server 430 as described above with reference to FIGS. 1-4. The API 110 is arranged to receive commands from and send commands to the user device 410.

The user account objects, such as user account object 132 described above form one or more pools of user account objects stored in a database 130. The database is stored in storage 430 of the system. The storage 430 may be a solid-state drive (SSD) or other semiconductor-based RAM; a ROM, for example, a CD ROM or a semiconductor ROM; a magnetic recording medium, for example, a floppy disk or hard disk; optical memory devices in general, although it will be appreciated that other storage mediums may be used. The storage 430 may be accessed via a local area LAN, a WAN, and/or a public network (e.g. the Internet) via a network adaptor. The network adapter may be configured to communicate using either a wired or wireless communication method, such as cellular connectivity (LTE, 3G, 4G, or 5G), ethernet, or over a Wi-Fi network. Whilst the storage 430 is shown as separate from the other resources of the system 400, it will be appreciated that the storage 430 may form part of the intermediary server 420, or maybe a virtual component associated with at least one of the isolated network segments 150a, 150b. In yet further examples, the storage 430 may be located on a server remote from the intermediary server 420.

The system 400 also comprises at least one remote server 430 for providing at least one isolated network segment 150a, 150b, such as a virtual private cloud representative of the digital environment. The remote server 430 may be an AWS server or other server provided by an alternative cloud services provider; furthermore, multiple remote servers may be used, each being provided by a separate cloud computing service provider. The remote server 430 facilitates the dynamic creation of isolated network segments 150a, 150b and instantiates, within each of the isolated network segments 150a, 150b, at least one resource (not shown). As mentioned previously, the resources may include virtual machines, containers, and remote storage, or any combination of resources that can be dynamically instantiated and assigned by the remote server 430 on demand. The isolated network segments 150a, 150b may represent a virtual network of resources illustrative of a real-world network configuration. User account objects 132-136 are allocated to the isolated network segments 150a, 150b configured to undertake the task requested by the user, and resources (not shown) of the isolated network segments 150a, 150b can send and receive commands to/from the user device 410 to facilitate the completion of a task.

As described above, some examples comprise an intermediary component (not shown), such as intermediary component 140 of FIGS. 1 and 4, which may form part of the intermediary server 420, or maybe a virtual component associated with at least one of the isolated network segments 150a, 150b. In yet further examples, the intermediary component comprises some aspects which are virtual and form part of the isolated network segments 150a, 150b, and other aspects which form part of the intermediary server 420. Furthermore, the intermediary component may be located on a server remote from the intermediary server 420.

At least some aspects of the embodiments described herein with reference to FIGS. 1-5 comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

It is to be understood that although the disclosure above relates to the use of cloud computing, the implementation described is not limited to a cloud computing environment. Rather, embodiments of the present disclosure are capable of being implemented in conjunction with any other type of computing environment.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A method for managing user account objects within a digital environment via a framework, the framework comprising:
an application programming interface, API, the API enabling a user to send and receive commands to the digital environment;
a database comprising a plurality of user account objects, each user account object being associated with a pool of user account objects; and
at least one isolated network segment configured to perform one or more tasks, the at least one isolated network segment comprising a plurality of dynamically instantiable resources;
the method comprising the steps of:
receiving a request, via the API, from the user to perform a task of the one or more tasks;
activating a user account object from the database, by associating the user account object with the user and the at least one isolated network segment;
configuring the user account object for performing the requested task;
receiving at the at least one isolated network segment, at least one command from the user, to enable the requested task to be completed within the at least one isolated network segment, wherein the at least one command is sent by the user using the configured user account object; and
deallocating the user account object upon detection of a completion indication from the at least one isolated network segment indicating the completion of the requested task, wherein deallocation comprises dissociating the user account object with the user and associating the user account object with the pool of user account objects.

2. The method according to claim 1, wherein the step of configuring the user account object comprises provisioning one or more attributes of the user account object for performing the requested task.

3. The method according to claim 1, wherein a plurality of user account objects are activated and allocated to the user and, wherein the step of configuring the plurality of user account objects comprises provisioning each of the plurality of user account objects with differing attributes for performing the requested task.

4. The method according to claim 1, further comprising selecting one or more pre-provisioned user account objects from the database, the one or more pre-provisioned user account objects comprising at least one required attribute for performing the requested task.

5. The method according to claim 2, wherein the attributes comprise at least a security level configured to limit access of the user to at least one of the dynamically instantiable resources of the at least one isolated network segment based on the requested task.

6. The method according to claim 1, further comprising the step of instantiating the at least one isolated network segment by configuring the plurality of dynamically instantiable resources for performing the requested task.

7. The method according to claim 1, wherein the plurality of dynamically instantiable resources of the at least one isolated network segment are pre-configured for performing the one or more tasks.

8. The method according to claim 1, wherein the user, and the allocated user account object, are associated with a given organization.

9. The method according to claim 1, wherein the at least one command received by the at least one isolated network segment is received via an intermediary component.

10. The method according to claim 1, wherein the step of deallocating the user account object further comprises resetting the user account object.

11. A system for managing user account objects within a digital environment, the system comprising:
a user device for accessing the digital environment;
storage for storing a database comprising a plurality of user account objects, each user account object being associated with a pool of user account objects;
an intermediary server comprising an application programming interface, API, the API enabling a user to send and receive commands via the user device; and
a remote server for providing at least one isolated network segment configured to perform one or more tasks, the at least one isolated network segment comprising a plurality of dynamically instantiable resources;
wherein the intermediary server is configured to:
receive a request through the API from the user device to perform a task of the one or more tasks;
activate a user account object from the database, by associating the user account object with the user and the at least one isolated network segment;
configure the user account object for performing the requested task;
receive at the at least one isolated network segment, at least one command from the user device, to enable the requested task to be completed within the at least one isolated network segment, wherein the at least one command is sent using the configured user account object; and
deallocate the user account object upon detection of a completion indication from the at least one isolated network segment indicating the completion of the requested task, wherein deallocation comprises dissociating the user account object from the user device and associating the user account object with the pool of user account objects.

12. The system according to claim 11, wherein the intermediary server is configured to configure the user account object by provisioning one or more attributes of the user account object for performing the requested task.

13. The system according to claim 11, wherein the intermediary server is configured to activate a plurality of user account objects and allocate the plurality of user account objects to the user device and, wherein the intermediary server is configured to configure the user account objects by provisioning each of the plurality of user account objects with differing attributes for performing the requested task.

14. The system according to claim 11, wherein the intermediary server is configured to select one or more pre-provisioned user account objects from the database, the one or more pre-provisioned user account objects comprising at least one required attribute for performing the requested task.

15. The system according to claim 12, wherein the attributes comprise at least a security level configured to limit access of the user to at least one of the dynamically instantiable resources of the at least one isolated network segment based on the requested task.

16. The system according to claim 11, wherein the intermediary server is configured to instruct the instantiation of the at least one isolated network segment by configuring the plurality of dynamically instantiable resources for performing the requested task.

17. The system according to claim 11, wherein the plurality of dynamically instantiable resources of the at least one isolated network segment are pre-configured for performing the one or more tasks.

18. The system according to claim 11, wherein the user, and the configured user account object, are associated with a given organization.

19. The system according to claim 11, wherein the intermediary server is configured to deallocate the user account object by resetting the user account object.

20. A non-transitory computer-readable storage medium comprising a set of computer-readable instructions stored thereon, which when executed by at least one processor are arranged to manage user account objects within a digital environment via a framework, the framework comprising:
an application programming interface, API, the API enabling a user to send and receive commands to the digital environment;
a database comprising a plurality of user account objects, each user account object being associated with a pool of user account objects; and
at least one isolated network segment configured to perform one or more tasks, the at least one isolated network segment comprising a plurality of dynamically instantiable resources;
wherein managing the user account objects in the digital environment comprises the steps of:
receiving a request, via the API, from the user to perform a task of the one or more tasks;
activating a user account object from the database, by associating the user account object with the user and the at least one isolated network segment;
configuring the user account object for performing the requested task;
receiving at the at least one isolated network segment, at least one command from the user, to enable the requested task to be completed within the at least one isolated network segment, wherein the at least one command is sent by the user using the configured user account object; and
deallocating the user account object upon detection of a completion indication from the at least one isolated network segment indicating the completion of the requested task, wherein deallocation comprises dissociating the user account object with the user and associating the user account object with the pool of user account objects.
